(19) United States
(12) Patent Application Publication
(10) Pub. No.: US 2004/0158022 A1
(43) Pub. Date: Aug. 12, 2004

(54) Rheologicval adjunct method for production and use thereof

(76) Inventors: Hubert Baumgart, Munster (DE); Ingrid Heid, Munster (DE); Ulrike Rockrath, Senden (DE); Helmut Kleine Beckmann, Ostbevern (DE); Ulrich Poth, Munster (DE)

Correspondence Address: BASF CORPORATION, ANNE GERRY SABOURIN, 26701 TELEGRAPH ROAD, SOUTHFIELD, MI, 48034-2442, US

(21) Appl. No.: 10/476,923

(22) PCT Filed: May 24, 2002
(86) PCT No.: PCT/EP02/05702

(30) Foreign Application Priority Data
Jun. 1, 2001 (DE) 101 26 647.2

(51) Int. Cl. C08G 18/32; C08G 18/60

(52) U.S. Cl. 528/68; 427/402

(57) ABSTRACT

A rheological aid comprising at least one urea derivative preparable by reacting

(A) at least one polyisocyanate with

(B) at least one polyamine with primary and/or secondary amino groups and at least one primary and/or secondary monoamine and/or water; and its use to prepare pseudoplastic coating materials, adhesives, and sealing compounds.

The present invention relates to a novel rheological aid. The present invention further relates to a novel process for preparing rheological aids. The present invention additionally relates to the use of the novel rheological aid for preparing coating materials, adhesives, and sealing compounds.

Rheological aids for establishing pseudoplasticity (cf. Römpp Lexikon Lacke und Druckfarben, Georg Thieme Verlag, Stuttgart, New York, 1998, “pseudoplasticity”, page 546) and pseudoplastic coating materials comprising them have been known for a long time.

The use of rheological aids in coating materials is intended among other things to make it possible to apply comparatively thick films without the occurrence of disruptive runs. Particularly in the case of nonaqueous coating materials comprising a Theological aid based on urea derivatives, the resulting film surfaces, at any rate at high solids contents, are unsatisfactory in their visual appearance (especially leveling and gloss) and, moreover, also lead to coatings which lack sufficient condensation resistance (and blush owing to water inclusion).

The international patent application WO 00/31194 discloses rheological aids comprising urea derivatives and polymers containing pendant or terminal carbamate groups. The urea derivatives may be prepared by reacting monoamines with polyisocyanates in the presence of these polymers. The coating materials provided with the Theological aids may also comprise surface-active substances (surfactants; cf. Römpp, op. cit., page 271, “surface-active substances”). The rheological aids improve the pseudoplasticity of the coating materials provided with them and effectively suppress the tendency to run. The coatings produced therefrom have a high gloss and a high level of hardness.

The international patent application WO 00/37520 discloses urea derivatives preparable by reacting at least one amine, particularly a monoamine, with at least one polyisocyanate in the presence of at least one amino resin, and their use as rheological aids. The rheological aids are said to be universally employable. The patent application does not reveal whether—and if so to what extent—these rheological aids influence the storage stability and circulation stability of the pseudoplastic coating materials, adhesives, and sealing compounds, and the brightness of the coatings, adhesive films, and seals produced from them.

The German patent applications DE 199 24 170 A 1, DE 199 24 171 A 1 and DE 199 24 172 A 1 disclose rheological aids preparable from monoamines and polyisocyanates, and pseudoplastic coating materials which possess comparatively good storage stability. As far as leveling, surface smoothness, intercoat adhesion, and condensation resistance are concerned, the coatings produced from them have a well-balanced profile of properties. The stability under static conditions (storage stability) and under dynamic conditions (transit stability and circulation stability) of the pseudoplastic coating materials, and the brilliance of the coatings produced from them, however, are still in need of further improvement.

The German patent application DE 100 42 152.0, unpublished at the priority date of the present specification, discloses rheological aids which can be activated with actinic radiation. They are prepared by reacting a monoamine, such as benzylamine, with a polyisocyanate, such as hexamethylene diisocyanate, in the presence of a compound containing at least one functional group having at least one bond which can be activated with actinic radiation, such as dipenta-erythritol pentaacrylate. The mixtures of urea derivative and dipentaerythritol pentaacrylate are used to prepare coating materials which can be cured with actinic radiation or both thermally and with actinic radiation (dual cure). These coating materials may comprise binders containing allophanate groups and/or carbamate groups and also, if desired, functional groups having at least one bond which can be activated with actinic radiation, such as acrylate groups. They may further comprise aminoresin crosslinking agents. In addition, they may comprise customary and known binders curable solely with actinic radiation, such as (meth)acryloyl-functional (meth)acrylate copolymers, polyether acrylates, polyester acrylates, unsaturated polyesters, epoxy acrylates, urethane acrylates, amino acrylates, melamine acrylates, silicone acrylates, and the corresponding methacrylates, and customary and known reactive diluents which are curable with actinic radiation and have a functionality of up to four and are described in Römpp Lexikon Lacke und Druckfarben, Georg Thieme Verlag, Stuttgart, New York, 1998, ‘reactive diluents’, pages 491 and 492, such as pentaerythritol tetraacrylate, for example.

It is an object of the present invention to find a novel rheological aid, based on urea derivatives, which further improves the stability of pseudoplastic coating materials, adhesives, and sealing compounds under both static and dynamic conditions and significantly enhances the brilliance of the coatings produced from the pseudoplastic coating materials.

The invention accordingly provides the novel rheological assistant comprising at least one urea derivative preparable by reacting

(A) at least one polyisocyanate with

(B) at least one polyamine with primary and/or secondary amino groups and at least one primary and/or secondary monoamine and/or water.

In the text below the novel rheological aid comprising at least one urea derivative is referred to as the “rheological aid of the invention”.

The invention also provides the novel process for preparing rheological aids comprising at least one urea derivative, which comprises reacting

(A) at least one polyisocyanate with

(B) at least one polyamine with primary and/or secondary amino groups and at least one primary and/or secondary monoamine and/or water,

in an organic medium.

In the text below the novel process for preparing rheological aids comprising at least one urea derivative is referred to as the “process of the invention”.

The invention further provides for the use of the rheological aids of the invention for preparing novel coating materials, adhesives, and sealing compounds.

Further subject matter according to the invention will emerge from the following description.

In the light of the prior art it was surprising and unforseeable for the skilled worker that the object on which the present invention was based might be achieved by means of the rheological aids of the invention and of the process of the invention. A particular surprise was that the novel rheological aids could be produced reproducibly, simply and reliably, by means of the process of the invention. Especially surprising was that the rheological aids of the invention exhibited a particularly strong pseudoplasticity, which exceeded that of known rheological aids, and were extremely widely applicable. They gave coating materials, adhesives, and sealing compounds, but especially coating materials, which had particularly high storage, transit and circulation stability, were easy to apply, and exhibited very little if any tendency to run from vertical surfaces. The coatings produced from them showed excellent leveling and had no surface structures such as orange peel, craters or pinholes. The coatings were also highly brilliant.

The amount of the urea derivatives in the rheological aid of the invention may vary widely and is guided in particular by the target pseudoplasticity of the coating materials, adhesives, and sealing compounds of the invention. Preferably, the rheological aid of the invention comprises the urea derivatives in an amount, based on the rheological aid, of from 0.1 to 10, more preferably from 0.2 to 9, with particular preference from 0.3 to 8, with very particular preference from 0.4 to 7, and in particular from 0.5 to 6% by weight.

The rheological aid of the invention is preparable by reacting

at least one polyamine (B) with primary and/or secondary, especially primary, amino groups, especially a diamine (B), and

at least one primary and/or secondary monoamine (B) and/or water (B), preferably at least one primary and/or secondary monoamine, especially a primary monoamine (B)

with at least one polyisocyanate (A), especially a diisocyanate (A), preferably in an organic medium, the starting products (A) and (B) being used preferably in amounts such that the above-described amount of urea derivatives results.

Preferably, the starting products (A) and (B) are reacted with one another in amounts such that the equivalents ratio of isocyanate groups in (A) to the amino groups in (B) is from 2:1 to 1:2, more preferably from 1.8:1 to 1:1.8, with particular preference from 1.6:1 to 1:1.6, with very particular preference from 1.4:1 to 1:1.4, and in particular from 1.2:1 to 1:1.2.

It is of advantage in accordance with the invention if the equivalents ratio of amino groups in the polyamines (B) to the amino groups in the monoamines (B) is from 4:1 to 1:2 preferably from 3:1 to 1:1, with particular preference from 2:1 to 1:1, with very particular preference from 1.5:1 to 1:1, and in particular from 1.2:1 to 1:1.

The polyamines (B) are selected from the group of the aliphatic, cycloaliphatic, aromatic, aliphatic-aromatic, cycloaliphatic-aromatic, and aliphatic-cycloaliphatic polyamines. A polyamine (B) is referred to, for example, as an aliphatic-aromatic polyamine if at least one amino group is attached to an aliphatic group and at least one amino group is attached to an aromatic group. This nomenclature rule is to apply correspondingly to the other groups of polyamines (B).

Preferably, the polyamines (B) are selected from the group consisting of aliphatic and cycloaliphatic polyamines. Examples of suitable polyamines (B) are known from the international patent application WO 00/37520, page 4 lines 6 to 19. The polyamines (B) selected are preferably those from the group consisting of polyethyleneimine, triethylenetetramine, diethylenetriamine, tripropylenetetramine, dipropylenetriamine, methylenediamine, ethylenediamine, 1,2- and 1,3-propylenediamine, 1,4-, 1,3-, and 1,2-butanediamine, 1,4-, 1,3-, and 1,2-diaminocyclohexane, and 1,4-, 1,3-, and 1,2-di(aminomethyl)benzene.

The monoamines (B) are selected from the group of the aliphatic, cycloaliphatic and aromatic, especially of the aliphatic, monoamines. A monoamine (B) is referred to, for example, as an aromatic monoamine if the amino group is attached to an aromatic group. This nomenclature rule is to apply correspondingly to the other groups of monoamines (B).

Examples of suitable monoamines (B) are known from the German patent applications DE 199 24 172 A1, page 3 lines 3 to 10, and DE 199 24 171 A1, page 3 lines 35 to 42, or the international patent applications WO 00/31194, page 11 lines 14 to 29, and WO 00/37520, page 3 line 15 to page 4 line 5. Particular preference is given to using methoxypropylamine, benzylamine and/or n-hexylamine.

Examples of suitable polyisocyanates (A) are diisocyanates, such as tetramethylene 1,4-diisocyanate, hexamethylene 1,6-diisocyanate, 2,2,4-trimethylhexamethylene 1,6-diisocyanate, omega,omega′-dipropyl ether diisocyanate, cyclohexyl 1,4-diisocyanate, cyclohexyl 1,3-diisocyanate, cyclohexyl 1,2-diisocyanate, dicyclohexylmethane 4,4′-diisocyanate, 1,5-dimethyl-2,4-di(isocyanatomethyl)benzene, 1,5-dimethyl-2,4-di(iso-cyanatoethyl)benzene, 1,3,5-trimethyl-2,4-di(iso-cyanatomethyl)benzene, 1,3,5-triethyl-2,4-di(iso-cyanatomethyl)benzene, isophorone diisocyanate, dicyclohexyldimethylmethane 4,4′-diisocyanate, 2,4-tolylene diisocyanate, 2,6-tolylene diisocyanate, and diphenyl methane 4,4′-diisocyanate.

Further suitable examples of suitable polyisocyanates (A) are triisocyanates such as nonane triisocyanate (NTI).

It is also possible to use polyisocyanates (A) based on the above-described diisocyanates and triisocyanates (A). The corresponding polyisocyanates are oligomers containing isocyanurate, biuret, allophanate, iminooxadiazinedione, urethane, carbodiimide, urea and/or uretdione groups. Examples of suitable preparation processes are known, for example, from patents and patent applications CA 2,163,591 A1, U.S. Pat. No. 4,419,513 A, U.S. Pat. No. 4,454,317 A, EP 0 646 608 A1, U.S. Pat. No. 4,801,675 A, EP 0 183 976 A1, DE 40 15 155 A1, EP 0 303 150 A1, EP 0 496 208 A1, EP 0 524 500 A1, EP 0 566 037 A1, U.S. Pat. No. 5,258,482 A, U.S. Pat. No. 5,290 902 A, EP 0 649 806 A1, DE 42 29 183 A1, and EP 0 531 820 A1.

Very particular preference is given to using the oligomers (A) of hexamethylene diisocyanate and of isophorone diisocyanate. The above-described oligomers (A) advantageously have an NCO functionality of 2.0-5.0, preferably 2.2-4.0, in particular 2.5-3.8.

Also suitable are the high-viscosity polyisocyanates (A) as described in the German patent application DE 198 28 935 A 1.

Further examples of suitable polyisocyanates (A) are

Ia) isocyanates having at least one diisocyanate structural unit,

i) which has an unsaturated or aromatic or nonaromatic ring structure containing 5-10 ring atoms and

ii) has two isocyanate groups attached to the ring structure, where

iii) in the case of a nonaromatic ring structure

a) both isocyanate groups are attached to the ring structure via linear C₁-C₉ alkyl and/or linear C₂-C₁₀ ether alkyl, or

b) one isocyanate group is attached directly to the ring structure and the other is attached via linear C₂-C₉ alkyl and/or linear C₂-C₁₀ ether alkyl, and

iv) in the case of an unsaturated aromatic structure, at least one of the two isocyanate groups is attached to the ring structure via linear C₂-C₉ alkyl and/or linear C₂-C₁₀ ether alkyl, neither radical containing benzylic hydrogen atoms;

and/or

Ib) at least one oligomer of this isocyanate Ia) having 2 to 10 isocyanate units, in particular a trimer;

and/or

Ic) at least one partially blocked isocyanate Ia) and/or at least one partially blocked oligomer Ib).

The isocyanates Ia) may have two or more of these diisocyanate structural units, although it has been found appropriate to use only one.

Regarding the diisocyanate structural unit of the diisocyanate Ia) there are various possibilities for its further configuration, which are described below.

As far as the ring structure (i) is concerned it is possible in principle for the rings involved to be heteroatomic rings. In that case the ring atoms present in the ring structure (i) include not only carbon atoms but also ring atoms other than carbon, such as nitrogen, oxygen or silicon atoms, for example. The rings involved may be saturated or unsaturated, or aromatic, heteroatomic rings. Examples of suitable saturated heteroatomic rings are the silacyclopentane, silacyclohexane, oxolane, oxane, dioxane, morpholine, pyrrolidine, imidazolidine, pyrazolidine, piperidine or quinuclidine rings. Examples of suitable unsaturated or aromatic heteroatomic rings are pyrrole, imidazole, pyrazole, pyridine, pyrimidine, pyrazine, pyridazine or triazine rings. It is preferred if the ring atoms present in the ring structure (i) are exclusively carbon atoms.

The ring structure (i) may be free from bridges. Where the ring structure (i) is a bicyclic terpene framework, decalin, adamantane or quinuclidine, however, bridges may be present. Examples of suitable terpene frameworks are carane, norcarane, pinane, camphane or norbornane frameworks.

The hydrogen atoms of a diisocyanate structural unit Ia), especially the ring structure (i), may be substituted by groups or atoms which react neither with isocyanates nor with the amine and/or the binder. Examples of suitable groups are nitro, alkyl, cycloalkyl, perfluoroalkyl, perfluorocycloalkyl, and aryl groups. Examples of suitable atoms are halogen atoms, especially fluorine.

The ring structure (i) consists advantageously of 6 carbon atoms, especially in the form of cyclohexane or benzene.

Examples of suitable linear C₁-C₉ alkyl are methylene or ethylene and also tri-, tetra-, penta-, hexa-, hepta-, octa- or nonamethylene radicals, especially methylene radicals.

The linear C₂-C₁₀ ether alkyls are attached to the ring structure either via the oxygen atoms or via the alkanediyl radicals they contain. Preferably, they are attached to said structure via the oxygen atoms. The indices 2 to 10 denote that there are from 2 to 10 carbon atoms in the ether alkyls.

The ether alkyls may contain only one oxygen atom. It is of advantage if from 2 to 10, in particular from 2 to 5, oxygen atoms are present in the chain. In that case there are 1 or more, but especially 2, carbon atoms between 2 oxygen atoms.

Examples of suitable C₂-C₁₀ ether alkyls are

—(O—CH₂)ₘ—, where m=1 to 10,

—(O—C₂H₄)ₚ—, where p=1 to 5,

—(O—C₃H₆)_{q}—, where q=1 to 3 or

—(O—C₄H₈)ᵣ—, where r=1 to 2.

If the isocyanate Ia) contains at least one diisocyanate structural unit having a nonaromatic ring structure (i), especially cyclohexane, both isocyanate groups may be attached via —CH₂— preferably to positions 1 and 3 of the ring structure. Attachment to the 1,2 and 1,4 positions, however, is also possible. In that case the diisocyanate structural unit or the isocyanate Ia) has, for example, the formula C₆H₁₀(—CH₂—NCO)₂.

Alternatively, it is possible for one of the two isocyanate groups to be attached directly to a ring atom of a nonaromatic ring structure (i), especially cyclohexane, and for the second isocyanate group to be attached via C₂-C₉ alkyl, especially C₃ alkyl, to a further ring atom, preferably in 1,2 configuration. In that case the diisocyanate structural unit or the isocyanate Ia) has, for example, the formula C₆H₁₀(—NCO)(—C₃H₆—NCO)

If the isocyanate Ia) contains at least one diisocyanate structural unit having an unsaturated or aromatic ring structure (i), especially benzene, both isocyanate groups may be attached to said structure via C₂-C₉ alkyl. It is important that the alkanediyl radicals contain no benzylic hydrogen atoms, but in their stead carry substituents R¹ and R² which react neither with isocyanates nor with the amine or the binder. Examples of suitable substituents R¹ and R² are C₁-C₁₀ alkyl, aryl or halogen, preferably —CH₃.

Examples of suitable alkanediyl groups are, accordingly, —CR¹R²—(CH₂)ₙ— where n=1 to 8, especially 1 to 4, and R¹ and R²=the substituents indicated above.

The above-described alkanediyl groups are attached preferably to positions 1 and 3 of the benzene ring. In this case as well, however, attachment to positions 1,2 and 1,4 is possible. In that case, the diisocyanate structural unit or the isocyanate Ia) for use in accordance with the invention has, for example, the formula C₆H₄(—C(CH₃)₂—C₂H₄—NCO)₂.

Alternatively, the two isocyanate groups may be connected to the unsaturated or aromatic ring structure, especially benzene, via the above-described C₂-C₁₀ ether alkyls. It is important that the ether alkyls carry no benzylic hydrogen atoms. Where the ether alkyls are linked to the aromatic ring structure via carbon atoms, this can be achieved by ensuring that the benzylic carbon atoms carry the above-described substituents R¹ and R². If the ether alkyls are linked to the aromatic ring structure via oxygen atoms, no benzylic hydrogen atoms are present, which is why this variant is preferred.

Here again, it is possible for one of the two isocyanate groups to be attached directly to a ring atom of an unsaturated or aromatic ring structure (i), preferably a benzene ring, and for the second isocyanate group to be attached to a further ring atom, preferably in 1,2 configuration, for example, via C₃-C₉ alkyl containing no benzylic hydrogen atoms. In that case, the diisocyanate structural unit or the isocyanate Ia) for use in accordance with the invention has, for example, the formula C₆H₄(—NCO)(—C(CH₃)₂—(CH₂)₂—NCO).

Instead of or in addition to the isocyanate Ia) it is possible to use at least one oligomer Ib). The oligomer Ib) is prepared from the isocyanate Ia), the reaction involving advantageously from 2 to 10 monomer units, and trimerization being particularly preferred. The oligomerization and trimerization may lead, using customary and known, suitable catalysts, to the formation of uretdione, biuret, isocyanurate, iminooxadiazinedione, urea and/or allophanate groups.

Oligomerization is, however, also possible by reaction with low molecular mass polyols such as trimethylolpropane or homotrimethylolpropane, glycerol, neopentyl glycol, dimethylolcyclohexane, ethylene glycol, diethylene glycol, propylene glycol, 2-methyl-2-propyl-1,3-propanediol, 2-ethyl-2-butyl-1,3-propanediol, 2,2,4-trimethyl-1,5-pentanediol and 2,2,5-trimethyl-1,6-hexanediol, which, where required, are ethoxylated and/or propoxylated—partly, if desired—or otherwise rendered hydrophilic.

In addition to the diisocyanates and/or their oligomers and/or the isocyanates Ia) and/or their oligomers Ib), it is possible to use at least one partially blocked diisocyanate and/or its partially blocked oligomer and/or at least one partially blocked isocyanate Ia) and/or its partially blocked oligomer Ib) (i.e., isocyanate Ic)). Furthermore, instead of the diisocyanates and/or their oligomers and/or the isocyantes Ia) and/or their oligomers Ib), it is possible to use at least one partially blocked oligomer and/or at least one partially blocked oligomer Ib) (i.e., isocyanate Ic)).

For further details, reference is made to page 3 lines 10 to 51 of the German patent DE 198 11 471 A1 or to page 8 lines 4 to 23 of the international patent application WO 94/22968.

Examples of suitable blocking agents are the blocking agents known from the U.S. Pat. No. 4,444,954 A, such as i) phenols such as phenol, cresol, xylenol, nitrophenol, chlorophenol, ethylphenol, t-butylphenol, hydroxybenzoic acid, esters of this acid or 2,5-di-t-butyl-4-hydroxytoluene; ii) lactams, such as caprolactam, valerolactam, butyrolactam or propiolactam; iii) active methylenic compounds, such as diethyl malonate, dimethyl malonate, ethyl acetoacetate, methyl acetoacetate or acetylacetone; iv) alcohols such as methanol, ethanol, n-propanol, isopropanol, n-butanol, isobutanol, t-butanol, n-amyl alcohol, t-amyl alcohol, lauryl alcohol, ethylene glycol monomethyl ether, ethylene glycol monoethyl ether, ethylene glycol monopropyl ether, ethylene glycol monobutyl ether, diethylene glycol monomethyl ether, diethylene glycol monoethyl ether, propylene glycol monomethyl ether, methoxymethanol, glycolic acid, glycolic esters, lactic acid, lactic esters, methylolurea, methylolmelamine, diacetone alcohol, ethylenechlorohydrin, ethylenebromohydrin, 1,3-dichloro-2-propanol or acetocyanohydrin; v) mercaptans such as butyl mercaptan, hexyl mercaptan, t-butyl mercaptan, t-dodecyl mercaptan, 2-mercaptobenzothiazole, thiophenol, methylthiophenol or ethylthiophenol; vi) acid amides such as acetoanilide, acetoanisidinamide, acrylamide, methacrylamide, acetamide, stearamide or benzamide; vii) imides such as succinimide, phthalimide or maleimide; viii) amines such as diphenylamine, phenylnaphthylamine, xylidine, N-phenylxylidine, carbazole, aniline, naphthylamine, butylamine, dibutylamine or butylphenylamine; ix) imidazoles such as imidazole or 2-ethylimidazole; x) ureas such as urea, thiourea, ethyleneurea, ethylenethiourea or 1,3-diphenylurea; xi) carbamates such as phenyl N-phenylcarbamate or 2-oxazolidone; xii) imines such as ethyleneimine; xiii) oximes such as acetone oxime, formaldoxime, acetaldoxime, acetoxime, methyl ethyl ketoxime, diisobutyl ketoxime, diacetyl monoxime, benzophenone oxime or chlorohexanone oximes; xiv) salts of sulfurous acid such as sodium bisulfite or potassium bisulfite; xv) hydroxamic esters such as benzyl methacrylohydroxamate (BMH) or allyl methacrylohydroxamate; or xvi) substituted pyrazoles, imidazoles or triazoles; and (xvii) mixtures of the stated blocking agents.

The above-described oligomers Ib) advantageously likewise have an NCO functionality of 2.0-5.0, preferably 2.2-4.0, especially 2.5-3.8.

For further details, refer to the international patent applications WO 00/31194, page 11 line 30 to page 12 line 26, and WO 00/37520, page 5 line 4 to page 6 line 27, or to the German patent applications DE 199 24 172 A 1, page 3 lines 11 to 23, DE 199 24 170 A 1, column 3 line 61 to column 6 line 68, and DE 199 24 171 A 1, page 3 line 43 to page 5 line 34.

As mentioned above, the reaction between the starting products (A) and (B) is preferably conducted in an organic medium.

The organic medium preferably comprises or consists of at least one compound selected from the group consisting of organic solvents and also low molecular mass, oligomer and polymer compounds curable thermally, with actinic radiation, and both thermally and with actinic radiation (Dual Cure).

The low molecular mass compounds are preferably selected from the group consisting of reactive diluents curable thermally and with actinic radiation and cross-linking agents curable thermally or thermally and with actinic radiation, and the oligomer and polymer compounds from the group consisting of random, alternating and block, linear, branched and comb addition (co)polymers curable thermally, with actinic radiation, or thermally and with actinic radiation (Dual Cure), of olefinic and unsaturated monomers, and also polyaddition resins and polycondensation resins.

Critical for the selection is that the above-described organic solvents and compounds do not disrupt the reaction between the starting products (A) and (B) by, for instance, reacting more rapidly with the polyisocyanates (A) than do the starting products (B).

The organic solvents are preferably selected from the solvents described in D. Stoye and W. Freitag (Editors), ‘Paints, Coatings and Solvents’, Second, Completely Revised Edition, Wiley-VCH, Weinheim, New York, 1998, ‘14.9. Solvent Groups’, pages 327 to 373.

Examples of suitable thermally curable reactive diluents are described in the German patent applications DE 198 09 643 A 1, DE 198 40 605 A 1 and DE 198 05 421 A 1; examples of suitable reactive diluents curable with actinic radiation are described in Römpp Lexikon Lacke und Druckfarben, Stuttgart, New York, 1998, page 491 and 492.

Here and below, actinic radiation means electromagnetic radiation, such as near infrared (NIR), visible light, UV radiation and X-rays, especially UV radiation, and corpuscular radiation, such as electron beams.

Examples of suitable crosslinking agents curable thermally or both thermally and with actinic radiation are amino resins, as described for example in Römpp, op. cit., page 29, “amino resins” in the textbook “Lackadditive” [Additives for Coatings] by Johan Bieleman, Wiley-VCH, Weinheim, New York, 1998, pages 242 ff., in the book “Paints, Coatings and Solvents”, second completely revised edition, edited by D. Stoye and W. Freitag, Wiley-VCH, Weinheim, New York, 1998, pages 80 ff., in the patents U.S. Pat. No. 4,710,542 A and EP 0 245 700 A1, and also in the article by B. Singh and coworkers, “Carbamylmethylated Melamines, Novel Crosslinkers for the Coatings Industry”, in Advanced Organic Coatings Science and Technology Series, 1991, Volume 13, pages 193 to 207; carboxyl-containing compounds or resins, as described for example in the patent DE 196 52 813 A1; epoxy-containing compounds or resins, as described for example in the patents EP 0 299 420 A1, DE 22 14 650 B1, DE 27 49 576 B1, U.S. Pat. No. 4,091,048 A and U.S. Pat. No. 3,781,379 A; excess polyisocyanates (A), as described above; fully or partially blocked polyisocyanates (A); unblocked isocyanato (meth)-acrylates in accordance with the European patent application EP 0 928 800 A1 or partially or fully blocked isocyanato (meth)acrylates in accordance with the European patent application EP 0 928 800 A1, as described in the German patent application DE 100 41 635.7, unpublished at the priority date of the present specification; and/or tris(alkoxycarbonylamino)-triazines as disclosed in the patents U.S. Pat. No. 4,939,213 A, U.S. Pat. No. 5,084,541 A, U.S. Pat. No. 5,288,865 A, and EP 0 604 922 A.

Examples of suitable addition (co)polymers, polyaddition resins, and polycondensation resins are disclosed in detail, for example, in the German patent application DE 199 24 172 A1, page 3 line 33 to page 5 line 21, the German patent application DE 199 24 171 A1, page 5 line 48 to page 7 line 37, or the German patent application DE 199 08 013 A1, column 5 line 44 to column 8 line 65 and column 9 lines 25 to 67.

The reaction of the starting products (A) and (B) has no special features in terms of its method but instead is carried out, for example, as described in the German patent application DE 199 24 171 A1, page 5 lines 35 to 40, the German patent application DE 199 24 172 A1, page 3 lines 22 to 27, or the international patent application WO 00/31194, page 12 line 23 to page 13 line 19. The reaction in the presence of, for example, amino resins takes place as described in the international patent application WO 00/37520, page 6 line 29 to page 8 line 14 and page 9 line 28 to page 10 line 32.

For the preparation of the urea derivatives on the tonne scale, an advantageous process is the continuous process known from the German patent application DE 199 03 283 A1, in which an inline dissolver is used as the mixing unit. In this case the weight ratio of above-described compound to the urea derivatives may be 100:1, preferably 90:1, more preferably 80:1, with particular preference 70:1, with very particular preference from 60:1, and in particular 50:1. Besides the above-described urea derivatives for use in accordance with the invention and the other constituents, the rheological aids of the invention may further comprise at least one wetting agent as described, for example, in the German patent application DE 199 24 171 A 1, page 2 line 63 to page 3 line 24, and/or at least one modified, pyrogenic silica as described, for example, in the German patent application DE 199 24 172 A1, page 3 lines 28 to 32.

The rheological aids of the invention have a particularly pronounced pseudoplasticity.

The rheological aids of the invention are extremely widely applicable and in particular are outstandingly suited to producing coating materials, adhesives, and sealing compounds. The coating materials, adhesives, and sealing compounds of the invention may be curable physically, thermally, with actinic radiation, and both thermally and with actinic radiation (dual cure).

Besides the rheological aid of the invention, the coating materials, adhesives, and sealing compounds of the invention may comprise, for example, the constituents described in detail in the German patent application DE 199 24 171 A1, page 5 line 47 to page 9 line 32. The coating materials, adhesives, and sealing compounds may be prepared by the process described in the German patent application on page 9 lines 33 to 54. Examples of suitable substrates and coating techniques are likewise described in the German patent application on page 9 line 55 to page 10 line 23. Examples of suitable processes for thermal curing and for curing with actinic radiation are disclosed, for example, in the international patent application WO 98/40170, page 17 line 18 to page 19 line 20.

The pseudoplastic coating materials of the invention are used in particular as clearcoat materials and/or as color and/or effect coating materials for the production of clearcoat systems and also single-coat or multicoat, color and/or effect, electrically conductive, magnetically shielding and/or fluorescent coatings.

The stability of the pseudoplastic coating materials, adhesives, and sealing compounds of the invention under static and dynamic conditions, especially the circulation stability, and also the running behavior during application and curing, are outstanding.

Accordingly, the pseudoplastic coating materials, adhesives, and sealing compounds of the invention are outstandingly suitable for coating, bonding, and of sealing motor vehicle bodies, parts of motor vehicle bodies, motor vehicles inside and out, buildings inside and out, doors, windows, and furniture, and also for coating, bonding, and sealing as part of the industrial coating of, for example, small parts such as nuts, screws, wheelrims or hubcaps, coils, containers, packaging, electrical components, such as motor windings or transformer windings, and of white goods, such as domestic appliances, boilers, and radiators.

The coatings of the invention produced from the pseudoplastic coating materials of the invention are hard, scratch-resistant, weathering-stable, chemically stable, and above all of an extremely high brilliance.

The adhesive films produced from the pseudoplastic adhesives of the invention durably connect a very wide variety of substrates bonded using them. Even under extreme climatic conditions and/or highly fluctuating temperatures, there is no loss of bond strength.

The seals produced from the pseudoplastic sealing compounds of the invention durably seal the substrates sealed using them, even in the presence of strongly aggressive chemicals.

Accordingly, the substrates coated with the coatings of the invention, bonded with the adhesive films of the invention and/or sealed with the seals of the invention possess an extremely long service life and a particularly high utility, which makes them particularly economic in production and use.

### INVENTIVE AND COMPARATIVE EXAMPLES

### Preparation Example 1

### The preparation of the Solution of a Thermally Curable Methacrylate Copolymer 1

813 parts by weight of an aromatic hydrocarbon fraction having a boiling range of 158-172° C. were weighed into an appropriate reactor equipped with a stirrer, two dropping funnels for the monomer mixture and the initiator solution, a nitrogen inlet pipe, a thermometer and a reflux condenser. The solvent was heated to 140° C. After it had reached 140° C., a monomer mixture of 483 parts by weight of n-butyl methacrylate, 663 parts by weight of styrene, 337 parts by weight of hydroxyethyl methacrylate and 31 parts by weight of methacrylic acid was metered into the reactor at a uniform rate over the course of 4 hours, and an initiator solution of 122 parts by weight of t-butyl perethylhexanoate in 46 parts by weight of the above-described aromatic solvent was metered into the reactor at a uniform rate over the course 4.5 hours. The additions of the monomer mixture and of the initiator solution were commenced simultaneously. After the end of the initiator feed, the reaction mixture was held at 140° C. for two more hours and then cooled. The resulting polymer solution had a solids content of 65%, determined in a forced air oven (1 h at 130° C.).

The solution of the methacrylate copolymer 1 was used as an organic medium for preparing the rheological aids of the invention.

### Preparation Example 2

### Preparation of the Solution of a Thermally Curable Methacrylate Copolymer 2

897 parts by weight of an aromatic hydrocarbon fraction having a boiling range of 158-172° C. were weighed into an appropriate reactor equipped with a stirrer, two dropping funnels for the monomer mixture and initiator solution respectively, a nitrogen inlet pipe, a thermometer and a reflux condenser. The solvent was heated to 140° C. After it had reached 140° C., a monomer mixture of 487 parts by weight (corresponding to 34% by weight, based on the monomer mixture) of t-butyl acrylate, 215 parts by weight (corresponding to 15% by weight, based on the monomer mixture) of n-butyl methacrylate, 143 parts by weight (10% by weight, based on the monomer mixture) of styrene, 572 parts by weight (40% by weight, based on the monomer mixture) of hydroxypropyl methacrylate and 14 parts by weight (1% by weight, based on the monomer mixture) of acrylic acid was metered into the reactor at a uniform rate over the course of 4 hours, and an initiator solution of 86 g of t-butyl perethylhexanoate in 86 g of the above-described( aromatic solvent was metered into the reactor at a uniform rate over the course 4.5 hours. The additions of the monomer mixture and of the initiator solution were commenced simultaneously. After the end of the initiator feed, the reaction mixture was held at 140° C. for two more hours and then cooled. The resulting polymer solution, diluted with a mixture of 1-methoxypropyl 2-acetate, butyl glycol acetate and butyl acetate, had a solids content of 54%, determined in a forced air oven (1 h at 130° C.), a hydroxyl number of 155 mg KOH/g solids, an acid number of 10 mg KOH/g solids and a viscosity of 23 dPas (measured on a 60% dilution of the polymer solution in the above-described aromatic solvent using an ICI cone and plate viscometer at 23° C.). The methacrylate copolymer 2 had a glass transition temperature Tg of 67° C.

The methacrylate copolymer 2 was used as binder.

### Preparation Example 3

### The Preparation of the Solution of a Thermally Curable Methacrylate Polymer 3

Preparation example 2 was repeated but replacing the monomer mixture described therein by a monomer mixture comprising, based on the monomer mixture,

23% by weight 2-ethylhexyl methacrylate,

11.1% by weight 2-ethylhexyl acrylate,

19.25% by weight n-butyl methacrylate,

46.1% by weight hydroxypropyl methacrylate, and

0.25% by weight acrylic acid.

The polymer solution had a solids content of 65% determined in a forced air oven (1 h at 130° C.), a hydroxyl number of 179 mg KOH/g solids, an acid number of 10 mg KOH/g solids and a viscosity of 7 dPas (measured on a 60% dilution of polymer solution in the above-described aromatic solvent using an ICI cone and plate viscometer at 23° C.).

The methacrylate copolymer 3 was used as binder.

### Preparation Example 4

### The Preparation of a polyisocyanate-based Crosslinking Agent

The crosslinking agent was prepared by mixing

54.8 parts by weight of a 90% dilution of the isocyanurate-type trimer of hexamethylene diisocyanate in solvent naphtha/butyl acetate 1:1 (Desmodur® N 3390 from Bayer AG),

35.2 parts by weight of the isocyanurate-type trimer of isophorone diisocyanate (Desmodur® Z4470, 70% strength, from Bayer AG), and

10 parts by weight of butyl acetate.

### Example 1

### The Preparation of the Inventive Rheological Aid 1

A 2 l glass beaker was charged with 485 g of the solution of the methacrylate copolymer 1 from preparation example 1, 2.24 g of ethylene diamine and 3.33 g of methoxypropylamine. To the initial charge there was added with vigorous stirring using a laboratory dissolver a solution of 9.43 g of hexamethylene diisocyanate in 100 g of butyl acetate, metered in over the course of 5 minutes. The reaction mixture was stirred thoroughly for a further 15 minutes. The resulting rheological aid 1 had a solids content of 55% by weight, determined in a forced air oven (1 h at 130° C.).

### Example 2

### The Preparation of the Inventive Rheological Aid 2

A 2 l glass beaker was charged with 485 g of the solution of the methacrylate copolymer 1 from preparation example 1, 2.18 g of ethylenediamine and 3.67 g of hexylamine. To the initial charge there were added with vigorous stirring using a laboratory dissolver a, solution of 9.15 g of hexamethylene diisocyanate in 100 g of butyl acetate, metered in over the course of 5 minutes. The reaction mixture was stirred thoroughly for a further 15 minutes. The resulting rheological aid 2 had a solids content of 65% by weight, determined in a forced air oven (1 h at 130° C.)

### Comparative Example C1

### The Preparation of the Noninventive Rheological Aid C1

A 2 l glass beaker was charged with 508 g of the solution of the methacrylate copolymer 1 from preparation example 1 and 13.4 g of benzylamine. To the initial charge there were added with vigorous stirring using a laboratory dissolver a solution of 10.56 g of hexamethylene diisocyanate in 68 g of butyl acetate, metered in over the course of 5 minutes. The reaction mixture was stirred thoroughly for a further 15 minutes. The resulting rheological aid C1 had a solids content of 59%, determined in a forced air oven (1 h at 130° C.).

### Examples 3 and 4 and Comparative Example C2

### The Pseudoplasticity of Rheology Aids 1, 2 and C1

The pseudoplasticity of rheology aids 1 (example 3), 2 (example 4) and C1 (comparative example C2) was determined using a rotational viscometer at different shear rates. Table 1 gives an overview of the results obtained.

TABLE 1
The pseudoplasticity of rheological aids 1, 2 and C1

| | Viscosity (mPas) | | |
|---|---|---|---|
| Examples and | at: | | |
| comparative | shear rate (1/s): | | |
| example | 10 | 100 | 1000 |
| 3 | 6460 | 2201 | 776 |
| 4 | 10,929 | 2748 | 863 |
| V2 | 3703 | 2397 | 954 |

The results demonstrate that the inventive rheological aids 1 and 2 had a more pronounced pseudoplasticity than the conventional rheological aid C1.

### Examples 5 and 6 and Comparative Examples C3 and C4

### The preparation of Inventive Pseudoplastic One-Component Clearcoat Materials (Examples 5 and 6) and of Noninventive One-Component Clearcoat Materials (Comparative Examples C3 and C4)

The clearcoat materials were prepared by mixing and homogenizing the constituents indicated in table 2.

TABLE 2
The material composition of the inventive pseudoplastic
one-component clearcoat materials (examples 5 and
6) and of the noninventive one-component clearcoat
materials (comparative examples C3 and C4)

| | Example/comparative | | | |
|---|---|---|---|---|
| | example: | | | |
| Constituent | 5 | 6 | V3 | V4 |
| commercial styrene-rich acrylic | 460 | 460 | 460 | 637 |
| resin; solids content: 90% by | | | | |
| weight hydroxyl number: 125 | | | | |
| rheological aid 1 | 177 | — | — | — |
| (example 1) | | | | |
| rheological aid 2 | — | 177 | — | — |
| (example 2) | | | | |
| rheological aid C1 | — | — | 177 | — |
| (comparative example C1) | | | | |
| commercial butanol-esterified | 206 | 206 | 206 | 206 |
| melamine resin | | | | |
| acid catalyst (Nacure ® 2500 | 10 | 10 | 10 | 10 |
| from King Industries) | | | | |
| UV absorber | 10 | 10 | 10 | 10 |
| free-radical scavenger | 10 | 10 | 10 | 10 |
| (HALS) | | | | |
| silicone-based leveling | 4 | 4 | 4 | 4 |
| additive | | | | |
| butanol | 30 | 30 | 30 | 30 |
| aromatic solvent with boiling | 53 | 53 | 53 | 53 |
| range of 158-172° C. | | | | |
| xylene | 17 | 17 | 17 | 17 |

The clearcoat materials of examples 5 and 6 and the clearcoat material of comparative example C3 exhibited a pronounced pseudoplastic flow behavior. The clearcoat materials of examples 5 and 6 had a significantly higher storage, transit, and circulation stability than the clearcoat materials of comparative examples C3 and C4, the nonpseudoplastic clearcoat material of comparative example C4 being exceeded in this respect by the clearcoat material of comparative example C3.

### Examples 7 and 5 and Comparative Examples C5 and C6

### The Production of Inventive Clearcoats (Examples 7 and 8) and of Noninventive Clearcoats (Examples C5 and C6)

The clearcoat of example 7 was produced using the clearcoat material of example 5.

The clearcoat of example 8 was produced using the clearcoat material of example 6.

The clearcoat of comparative example C5 was produced using the clearcoat material of comparative example C3.

The clearcoat of comparative example C6 was produced using the clearcoat material of comparative example C4.

To assess the running behavior (number and length of runs) and the brilliance, the clearcoat materials were applied to customary and known, vertical perforated panels with a diagonal series of perforations, and were baked in vertical position at 130° C. for 30 minutes. The running behavior and the brilliance were assessed visually. The results are given in table 3.

TABLE 3
Running behavior and brilliance of the inventive clearcoats
of examples 7 and 8 and of the noninventive clearcoats
of comparative examples C5 and C6

| Example/ | | |
|---|---|---|
| comparative | Running | |
| example | behavior | Brilliance |
| 7 | outstanding | very good |
| 8 | outstanding | very good |
| C5 | good | slightly turbid |
| C6 | poor | very good |

The results of table 3 showed that only the inventive clearcoats combined very good brilliance with outstanding running behavior.

### Examples 9 and 10 and Comparative Examples C7 and C8

### The Preparation of an Inventive (Example 9) and of a Noninventive (Comparative Example C7) Two-Component Clearcoat Material and Production of an Inventive (Example 10) and Noninventive (Comparative Example C8) Clearcoat from said Material

To prepare the clearcoat material of example 9 and that of comparative example C7, binder components were first of all prepared by mixing and homogenizing the constituents indicated in table 4. The binder components were mixed with the crosslinking component prior to application.

TABLE 4
Material composition of the clearcoat materials of example
9 and of comparative example C8, and their properties

| | | Comparative |
|---|---|---|
| Constituent | Example 9 | example C7 |
| Binder component: | | |
| Methacrylate copolymer 3 from | 50 | 50 |
| preparation example 3 | | |
| Setalux ® 81753 from Akzo | — | 16 |
| (commercial rheology aid) | | |
| inventive rheological aid from | 16 | — |
| example 1 with 0.5% by weight | | |
| of commercial wetting agent | | |
| (Disperbyk ® 161) | | |
| methacrylate copolymer 2 from | 10 | 10 |
| preparation example 2 | | |
| GB ester (butyl glycolate) | 5 | 5 |
| Cyasorb ® UV 1164L (commercial | 1.5 | 1.5 |
| UV absorber) | | |
| butyl glycol acetate | 5.6 | 5.6 |
| Tinuvin ® 192 (commercial | 1 | 1 |
| reversible free-radical | | |
| scavenger) | | |
| Butanol | 1.6 | 1.6 |
| Byk ® ES 80 (commercial wetting | 0.3 | 0.3 |
| agent) | | |
| Xylene | 1.5 | 1.5 |
| dibasic ester (commercial | 2 | 2 |
| mixture of the dimethyl esters | | |
| of glutaric, adipic, and | | |
| sebacic acid) | | |
| Byk ® 325 (commercial leveling | 0.2 | 0.2 |
| agent) | | |
| butyl glycol acetate | 5.3 | 5.3 |
| crosslinking component: | | |
| crosslinking agent from | 50 | 50 |
| preparation example 4 | | |
| addition of butyl acetate to | 4.2 | 4.2 |
| give a spray viscosity of 25 to | | |
| 26 s in the DIN 4 efflux cup at | | |
| 23° C. (% by weight) | | |
| properties: | | |
| original viscosity in DIN 4 | 34 | 34 |
| efflux cup at 23° C. | | |
| solids content at spray | 47.5 | 47.1 |
| viscosity (1 hour/130° C.) | | |
| air inclusions following | none | none |
| adjustment to spray viscosity | | |
| pseudoplasticity at | 113 | 116 |
| shear rate 10 1/s | | |
| shear rate 1000 1/s | 93 | 84 |

To assess the running behavior (number and length of runs) and the brilliance, the clearcoat materials of example 9 and of comparative example C7 were applied to customary and known, vertical perforated panels with a diagonal series of perforations, and were baked in vertical position at 140° C. for 30 minutes. The running behavior and the brilliance were assessed visually.

The clearcoat materials were very easy to apply. Their running behavior was outstanding. However, the clearcoat of example 10 had a significantly higher brilliance than that of comparative example C8.

What is claimed is:

1. A rheological aid comprising at least one urea derivative preparable by reacting
(A) at least one polyisocyanate with
(B) at least one polyamine with primary and/or secondary amino groups and at least one primary and/or secondary monoamine and/or water.

2. The rheological aid as claimed in claim 1, wherein the polyisocyanate (A) is a diisocyanate.

3. The rheological aid as claimed in claim 1 or 2, wherein polyamine (B) is a primary polyamine.

4. The rheological aid as claimed in any of claims 1 to 3, wherein the polyamine (B) is a diamine.

5. The rheological aid as claimed in any of claims 1 to 4, wherein the monoamine (B) is a primary amine.

6. The rheological aid as claimed in any of claims 1 to 5, wherein (B) consists of polyamines and monoamines.

7. The rheological aid as claimed in claim 6, wherein the equivalent ratio of isocyanate groups in (A) to the amino groups in (B) is from 2:1 to 1:2.

8. The rheological aid as claimed in claim 6 or 7, wherein the equivalent ratio of amino groups in the polyamines (B) to the amino groups in the monoamines (B) is from 4:1 to 1:2.

9. The rheological aid as claimed in claim 8, wherein the equivalent ratio is from 3:1 to 1:1.

10. The rheological aid as claimed in one of claims 1 to 9, wherein the polyamines (B) are selected from the group consisting of polyethylemeimine, triethylenetetraamine, diethylenetriamine, tripropylenetetraamine, dipropylenetriamine, methylenediamine, ethylenediamine, 1,2- and 1,3-propylenediamine, 1,4-, 1,3-, and 1,2-butanediamine, 1,4-, 1,3-, and 1,2-diaminocyclohexane, and 1,4-, 1,3-, and 1,2-di(aminomethyl)benzene.

11. The rheological aid as claimed in any of claims 1 to 10, wherein the urea derivatives are preparable by reacting the starting products (A) and (B) in the presence of at least one compound selected from the group consisting of low molecular mass, oligomeric, and polymeric compounds curable physically, thermally, with actinic radiation, and both thermally and with actinic radiation (dual cure).

12. The rheological aid as claimed in claim 11, wherein the low molecular mass compounds are selected from the group consisting of reactive diluents curable thermally and with actinic radiation and crosslinking agents curable thermally or both thermally and with actinic radiation, and the oligomeric and polymeric compounds are selected from the group consisting of random, alternating and block, linear, branched and comb addition (co)polymers of olefinically unsaturated monomers, and also polyaddition resins and polycondensation resins, which are curable physically, thermally, with actinic radiation, and both thermally and with actinic radiation (dual cure).

13. The rheological aid as claimed in any of claims 1 to 12, comprising at least one further constituent selected from the group consisting of silicas and wetting agents.

14. A process for preparing a rheological aid as claimed in any of claims 1 to 13, which comprises reacting
(A) at least one polyisocyanate with
(B) at least one polyamine with primary and/or secondary amino groups and at least one primary and/or secondary monoamine and/or water,
in an organic medium.

15. The process as claimed in claim 14, wherein the organic medium comprises or consists of at least one compound selected from the group consisting of organic solvents and also low molecular mass, oligomeric, and polymeric compounds curable physically, thermally, with actinic radiation, and both thermally and with actinic radiation (dual cure).

16. The process as claimed in claim 15, wherein the low molecular mass compounds are selected from the group consisting of reactive diluents curable thermally and with actinic radiation and crosslinking agents curable thermally or both thermally and with actinic radiation, and the oligomeric and polymeric compounds are selected from the group consisting of random, alternating and block, linear, branched and comb addition (co)polymers of olefinically unsaturated monomers, and also polyaddition resins and polycondensation resins, which are curable physically, thermally, with actinic radiation, and both thermally and with actinic radiation (dual cure).

17. The use of the rheological aid as claimed in any of claims 1 to 13 to prepare coating materials, adhesives and sealing compounds.

18. The use as claimed in claim 17, wherein the coating materials, adhesives, and sealing compounds are curable physically, thermally, with actinic radiation, and both thermally and with actinic radiation (dual cure).

19. The use as claimed in claim 17 or 18, wherein the coating materials are used as clearcoat materials and/or as color and/or effect coating materials for producing clearcoats and also single-coat or multicoat, color and/or effect, electrically conductive, magnetically shielding and/or fluorescent coatings.

20. The use as claimed in any of claims 17 to 19, wherein the coating materials, adhesives or sealing compounds are used for coating, bonding, and sealing of motor vehicle bodies and parts thereof, motor vehicles inside and out, buildings inside and out, doors, windows, furniture, and also for coating, bonding, and sealing as part of the industrial coating of small parts, coils, containers, packaging, electrical components, and white goods.
